(19) United States
(12) Patent Application Publication
(10) Pub. No.: US 2026/0208224 A1
(43) Pub. Date: Jul. 23, 2026

(54) WINDOW GLAZING SYSTEM AND METHOD OF MANUFACTURING

(71) Applicant: GED Integrated Solutions, Inc., Glenwillow, OH (US)

(72) Inventors: Timothy B. McGlinchy, Twinsburg, OH (US); Scott Azzarello, Garfield HTS, OH (US); Dave Lewis, Hudson, OH (US); Michael Ritter, Hudson, OH (US)

(73) Assignee: GED Integrated Solutions, Inc., Glenwillow, OH (US)

(21) Appl. No.: 19/452,976

(22) Filed: Jan. 20, 2026

Related U.S. Application Data
(60) Provisional application No. 63/746,784, filed on Jan. 17, 2025.

(51) Int. Cl. B05C 11/10; B05C 5/02; B05D 1/26; B05D 1/40

(52) U.S. Cl. CPC B05C 11/1015; B05C 5/0204; B05C 5/0225; B05D 1/26; B05D 1/40

(57) ABSTRACT

A glazing system and method for use in sealing frames and sashes is disclosed herein. The system includes an articulating arm having a plurality of members and arms to allow movement about multiple axes defined by the articulating arm, coupled to a vision system circumferentially or centrally supporting sealant dispensing apparatus and a tactile sensor.

### CROSS REFERENCES TO RELATED APPLICATIONS

The following application claims priority under 35 U.S. C. § 119(e) to co-pending U.S. Provisional Patent Application Ser. No. 63/746,784 filed Jan. 17, 2025 entitled WINDOW GLAZING SYSTEM AND METHOD OF MANUFACTURING The above-identified provisional applications are incorporated herein by reference in their entireties for all purposes.

### TECHNICAL FIELD

The present disclosure relates to a window glazing system and method of manufacturing, more particularly, a window glazing system for a window frame or sash.

### BACKGROUND

Although automatic and semi-automatic glazing applicators for window frames and sashes have been available for several years on the market, they have limitations to accurately dispensing materials around corners of a sash, along non straight segments (bowed or warped segments of the sash). Some of the glazing machines have used the edge of the physical sash profile to guide the user or automatic system, it requires physical touching the units for guidance, leading to scratching or inconsistencies of application. Other glazing machines are inconsistent in sensing corner paths.

Typically, the sealant application is skipped, or the product bead varies leading to potential leaks or manual clean up on the glass in the assembly line and requires process inspection and or manual repair if sighted by manual inspection after placing glass into the sash. It is also desirable to reduce or eliminate worker product handling between workstations in the process. Moving a window sash and/or frame from the previous process station (removal of flash in PVC or Vinyl windows) causes delays in the process, causes potential scratches and worker fatigue.

Such sealant issues are discussed in U.S. Pat. Pub. No. 2017/0071030 to Briese et al., which is assigned to the assignee of the present disclosure and is incorporated herein by reference. Sealant dispensing, utilizing a sealant metering pump, is discussed in further detail in U.S. Pat. No. 7,048,964, to McGlinchy et al., which is assigned to the assignee of the present disclosure and is incorporated herein by reference

### SUMMARY

One aspect of the present disclosure utilizes a sealing dispenser having a sensor in which the sensor is capable of detecting defects in the sealant application and/or window sash. Defects include wherein vinyl sash systems have minimal strength and stability until a glass unit is added. Another aspect of the present disclosure utilizes a sealing dispenser having a sensor in which the sensor is capable of detecting defects (such as warpage and/or bending) in the sealant bead and/or window sash and compensating for differences in the dispensing of sealant through a local or network/system controller. Yet another aspect of the present disclosure utilizes a sealing dispenser having a sensor in which the sensor is capable of detecting defects in the sealant and/or window sash, such as volume and/or geometry of the sealant being dispensed. Another aspect of the present disclosure utilizes a sealing dispenser having a sensor in which the sensor is capable of detecting defects in the applied sealant bead and/or window sash. While another aspect of the present disclosure utilizes a sealing dispenser coupled to a sensor in which the sensor is capable of detecting defects in the sealant and/or window sash, such as but not limited to accurately dispensing materials around corners of a sash, along non straight segments (bowed or warped segments of the sash) accurately dispensing materials around corners of a sash, along non straight segments (bowed or warped segments of the sash) and compensates by communicating with a controller (local or system) to change the profile, volume, speed, and or directions in any cartesian coordinates along the sash.

Another aspect of the present disclosure utilizes a sealing dispenser having a sensor in which the sensor is of detecting defects in the sealant and/or window sash and compensating for differences in the dispensing of sealant through a local or network/system controller. It is desired to improve these limitations with automation during the process to improve quality, save sealant material and reduce labor in the manufacturing process. Methods and apparatus are described below to capture the invention.

One example embodiment of the present disclosure includes a glazing system for use in sealing frames and sashes. The glazing system includes a vision system circumferentially supporting a sealant dispensing apparatus coupled to a first arm, the vision system supporting a plurality of three dimensional (3D) sensors, wherein a nozzle of the sealant dispensing apparatus is centrally located between the plurality of 3D sensors, the sealant dispensing apparatus comprising the nozzle for dispensing sealant onto the frame or sash, the vision system for monitoring physical properties of the sealant during sealant application. The glazing system further includes a tactile sensor coupled to a second arm, the second arm spaced from and coupled to the first arm by a lateral arm, the tactile sensor for physically interacting with an frame or sash to identify type and size of the frame or sash, and a gear pump coupled to the nozzle, the gear pump for controlling a speed of sealant dispensing of the sealant dispensing apparatus. The glazing system further includes an articulating arm coupled to the lateral arm, the articulating arm having a plurality of members and arms to allow movement about multiple axes defined by the articulating arm, and a controller, coupled to and in communication with the articulating arm, the tactile sensor, the vision system, and the gear pump.

Another example embodiment of the present disclosure comprises a. method of utilizing a glazing system for use in sealing frames and sashes. The method includes the steps of receiving an identity of a sash or frame to be glazed, generating a glazing path on a surface of the frame or sash based upon the identity of the sash or frame, and moving sealant dispensing apparatus attached to an articulating arm to a starting point of the glazing path. The method further includes initiating sealant dispensing by the sealant dispensing apparatus circumferentially supported by a vision system to generate a bead on the glazing path, the bead having a predetermined width and height, monitoring the glazing path preceding and following the bead utilizing the vision system, and responsive to the vision system identifying a variation preceding the bead, identifying the coordinates of the variation, and altering the glazing path to a variation path on the sash or frame. The method additionally includes moving the sealant dispensing apparatus via the articulating arm to travel along the variation path, responsive to the sealant having been dispensed along the variation path, moving the sealant dispensing apparatus to return to the glazing path, and continuing dispensing sealant along the glazing path via the sealant dispensing apparatus. The method also includes responsive to the bead being dispensed along the glazing path and the variation path, completing the dispensing process.

Yet another example embodiment of the present disclosure includes a non-transitory computer readable medium storing instructions executable by an associated processor to perform a method for implementing a glazing system. The method includes identifying a sash or frame to be glazed, generating a glazing path passed upon the identity of the sash or frame, initiating sealant dispensing to generate a bead on the glazing path, the bead having a predetermined width and height. The method also includes monitoring the glazing path preceding and following the bead, responsive to identifying a variation preceding the bead, identifying the coordinates of the variation, and altering the glazing path to a vibration path on the sash or frame, responsive to glazing path having dispensed along the altered path, continuing dispensing sealant along the glazing path, and responsive to the bead being dispensed along the glazing path, completing the dispensing process.

### BRIEF DESCRIPTION OF THE DRAWINGS

The foregoing and other features and advantages of the present disclosure will become apparent to one skilled in the art to which the present invention relates upon consideration of the following description of the invention with reference to the accompanying drawings, wherein like reference numerals refer to like parts unless described otherwise throughout the drawings and in which:

FIG. 1 is an overview schematic block diagram of a glazing system;

FIG. 2 is a view of an integrated system including a glazing system;

FIG. 3 is a magnified view of an integrated system including a glazing system;

FIG. 4 is a right side elevation view of a sealant assembly in accordance with one example embodiment of the present disclosure;

FIG. 5 is a left side elevation view of the sealant assembly of FIG. 4;

FIG. 6 is a perspective view of the sealant assembly of FIG. 4 including a sash;

FIG. 7 is a top perspective view of a sealant assembly and articulating arm;

FIG. 8 is a side perspective view of a sealant assembly and articulating arm;

FIG. 9 is a right side perspective view of a sealant assembly interacting with a frame;

FIG. 10 is a front perspective view of a sash, in accordance with one example embodiment of the present disclosure;

FIG. 10a is a cross section of FIG. 10 taken along section lines 10a-10a;

FIG. 11 is a flow diagram of a method of sealant application;

FIG. 12 is a flow diagram of a method of sealant application;

FIG. 13 is a flow diagram of a method of sealant application;

FIG. 14 is a flow diagram of a method of sealant application; and

FIG. 15 is a flow diagram of a method of sealant application.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

Referring now to the figures generally wherein like numbered features shown therein refer to like elements throughout unless otherwise noted. The present disclosure relates to a window glazing system and method of manufacturing, more particularly, a window glazing system for a window frame or sash.

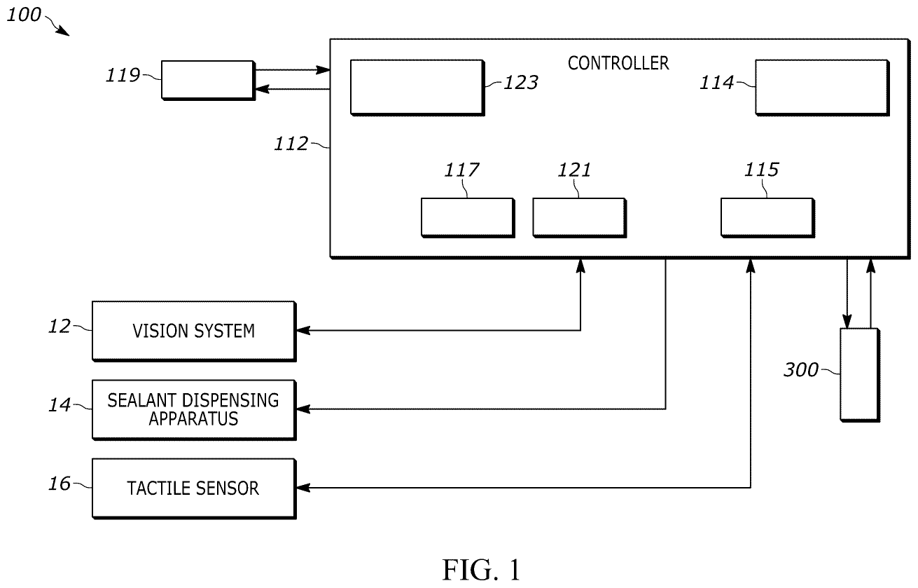

FIG. 1 illustrates a schematic diagram of a glazing system 100, in accordance with one of the exemplary embodiments of the disclosure. In one example embodiment, the glazing system 100 includes a controller 112. In one example embodiment, the controller 112 includes a computing device 115 (e.g. a database server, a file server, an application server, a computer, a programmable logic controller (PLC) or the like) with computing capability and/or a processor 114. The processor 114 comprises central processing units (CPU), such as a programmable general purpose or special purpose microprocessor, and/or other similar device or a combination thereof.

The controller 112 would generate outputs based upon inputs received from a vision system 12, a sealant dispensing apparatus 14, and/or a tactile sensor 16, cloud storage, a local input form a user, etc. It would be appreciated by one having ordinary skill in the art that in some embodiments the controller 112 would include a data storage device 117 in various forms of non-transitory, volatile, and non-volatile memories which would store buffered or permanent data as well as compiled programming codes used to execute functions of the controller 112. In another example embodiment, the data storage device 117 can be external to and accessible by the controller 112. In yet another example embodiment, the data storage device 117 includes an external hard drive, cloud storage, and/or other external recording devices 119. The controller 112 is one of independent of the vision system 12, the sealant dispensing apparatus 14, and/or the tactile sensor 16, or part of one or all of the vision system 12, the sealant dispensing apparatus 14, and/or the tactile sensor 16. In one example embodiment, the controller 112 includes or is communication with a robot controller 123, wherein the robot controller includes some or all of the same components as the controller. In this example embodiment, one of the controller 112 or the robot controller 123 controls an articulating arm 62 discussed in greater detail below. In one example embodiment, the robot controller 123 receives feedback from the articulating arm 62 and adjust movement of said articulating arm based on said input.

In one example embodiment, the controller 112 comprises one of a remote or local computer system 121. The computer system 121 includes desktop, laptop, tablet hand-held personal computing device, IAN, WAN, WWW, and the like, running on any number of known operating systems and are accessible for communication with remote data storage, such as a cloud, host operating computer, via a world-wide-web or Internet.

In another example embodiment, the controller 112 comprises a processor, a microprocessor, a data storage, computer system memory that includes random-access-memory (“RAM”), read-only-memory (“ROM”) and/or an input/output interface. The controller 112 executes instructions by non-transitory computer readable medium either internal or external through the processor that communicates to the processor via input interface and/or electrical communications, such as from the vision system 12, the sealant dispensing apparatus 14, and/or the tactile sensor 16. In yet another example embodiment, the controller 112 communicates with the Internet, a network such as a LAN, WAN, and/or a cloud, input/output devices such as flash drives, remote devices such as a smart phone or tablet, and displays.

In one example embodiment, the controller 112 includes or is in communication with an interactive display 300. In one example embodiment, the interactive display 300 is for receiving tactile input, either on a surface of the display or through a secondary input, such as a keypad. In another example embodiment, the interactive display 300 includes a secondary device, such as a smart phone, tablet, or the like. In another example embodiment, the controller 112, an SD-card-writer (e.g., for data retrieval), and the interactive display 300 (e.g., a touch-screen status-and-control LCD display) are housed in a separate module connected to the controller 112 and/or the vision system 12, the sealant dispensing apparatus 14, and/or the tactile sensor 16 via short range wireless signals, WIFI, and/or corded communication.

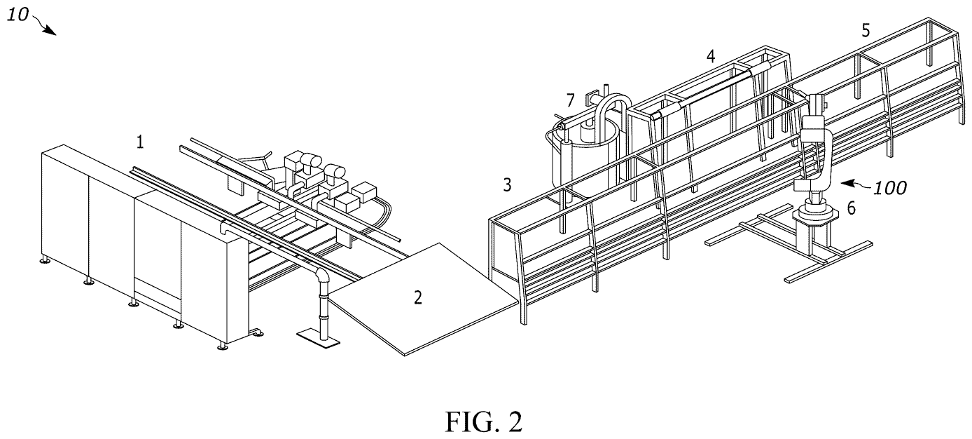

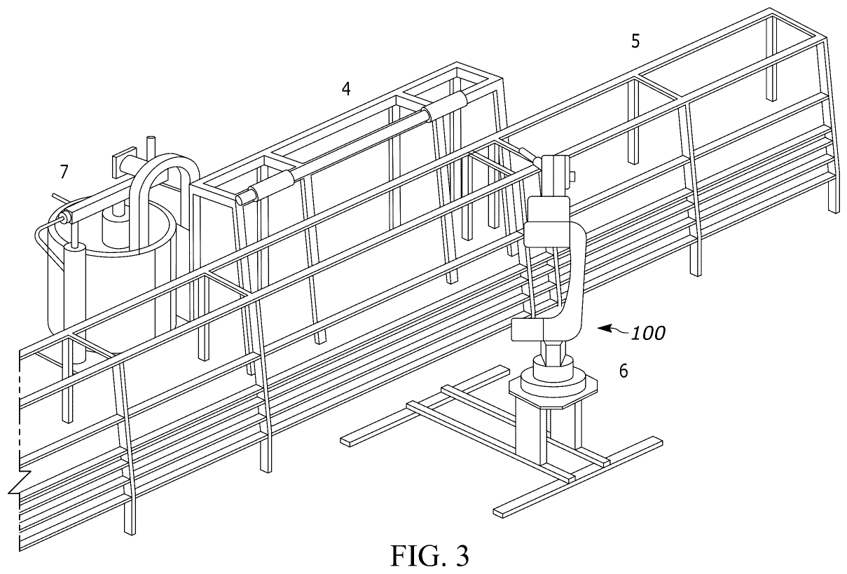

The glazing system 100 is illustrated in FIGS. 2-3 for dispensing and sensing the application of glaze or sealant on a window, window sash, or door. The glazing system 100 can be utilized as an integrated system 10 or a separated standalone independent system (such as cellular manufacturing) from a cleaning station (1) in the process of fabricating a PVC window sash/frame. Further details of a cleaning station is found in U.S. Patent Publication No. 2015/0063936, which is incorporated by reference in its entirety for all purposes.

The glazing system 100, as illustrated in FIG. 2, is part of the integrated system 10 with uninterrupted flow from station (1), the robotic cleaning station. A processed clean frame (removal of flash and machining of frame) is conveyed when finished to station (2), a horizontal to vertical (90 degree) transfer station. This transfer station eliminates the manual transition of moving and positioning the window frame or sash. The transfer station also moves the sash compared to a standalone or cellular system that could also use a multi-axis robot or arm with a seal or glaze dispenser disposed next to a multifunctional sensor.

Station (3) is optionally used for inspection, hardware installation, glazing block application and also as a buffer before the glazing system 100 to reduce transfer time between cycles of sealant application. The glazing system 100 includes the glazing operation discussed in greater detail herein.

After proper sealant application at the glazing system 100, the frame is conveyed to station 5 for insulating glass unit insertion and remaining glazing blocks. This vertical modular format of conveyors can be extended to also include glazing strip insertion and completion of hardware assembly to the sash or frame.

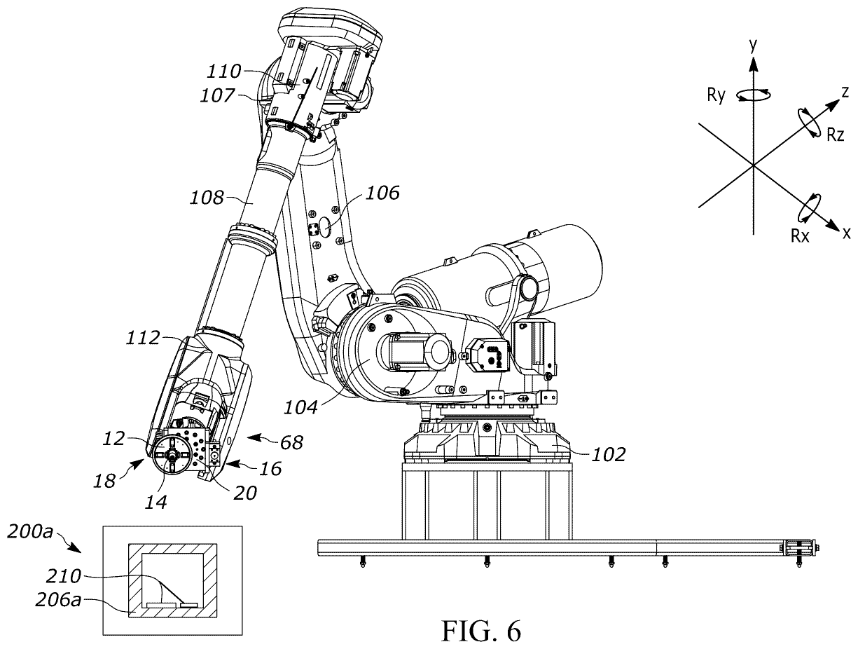

FIG. 1 schematically depicts the glazing system 100 for sealing or glazing window or door frames. The sashes and frames 200 comprise a frame 202 supporting a dispensing face 206(see FIGS. 6, 9 and 10). During assembly, sealant 204 is applied around the dispensing face 206 of the frame 202 and/or a dispensing face 206a of a sash 202a, wherein the dispensing face defines a glazing or sealant path. During assembly, the frame 202 and/or sash 202a accept the IGU by placing one of the glass lights of the IGU onto the sealant 204.

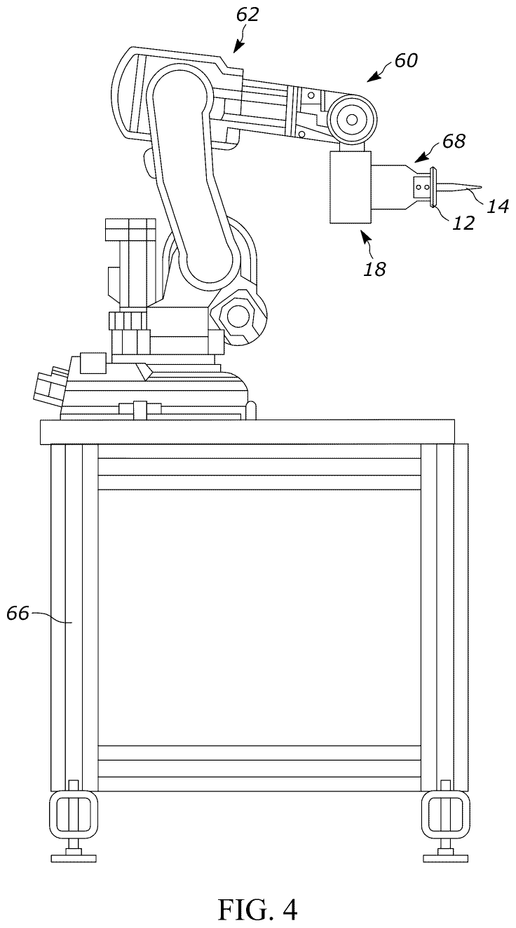

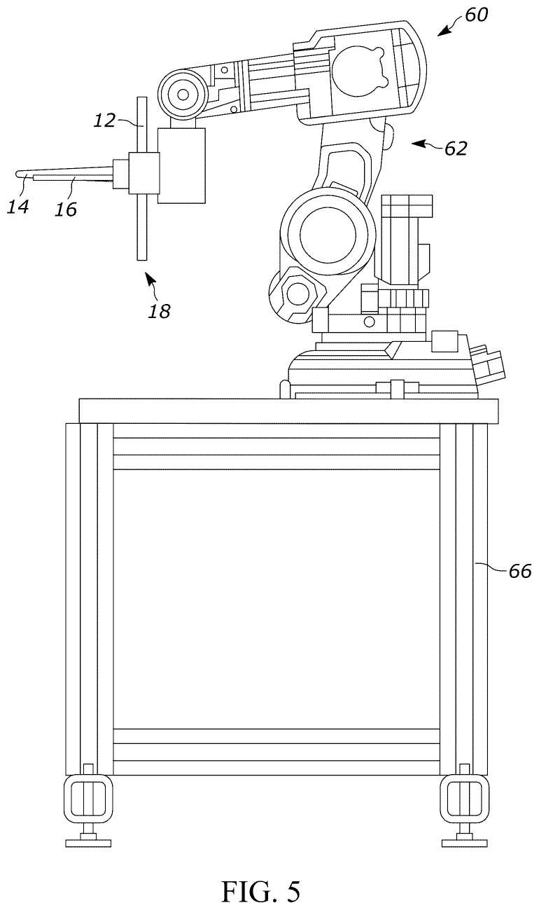

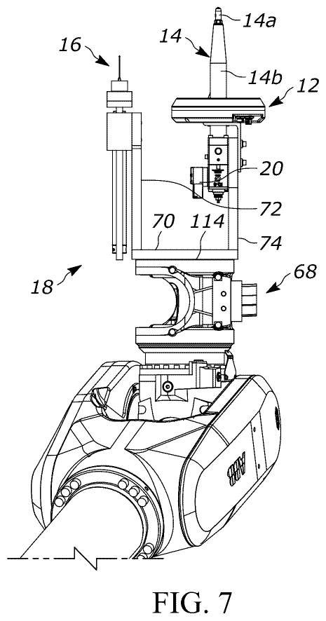

As illustrated in FIGS. 4-8, the glazing system 100 includes a sealant station 60, comprising an articulating arm 62, a vision system 12, a sealant dispensing apparatus 14, and a tactile sensor 16 in communication with the controller 112. In one example embodiment, the articulating arm 62 is selectively couplable to at least one of the tactile sensor 16, the sealant dispensing apparatus 14, or the visions system 12. In another example embodiment, the articulating arm 62 is coupled to the tactile sensor 16, the sealant dispensing apparatus 14, and the visions system 12 via a connection assembly 68. In one example embodiment, the connection assembly 68 couples to a sealant assembly 18 (for example, illustrated in FIG. 7). In this example embodiment, the sealant assembly 18 includes the vision system 12 circumferentially supporting the sealant dispensing apparatus 14, and the tactile sensor 16 laterally spaced from the sealant dispensing assembly 14.

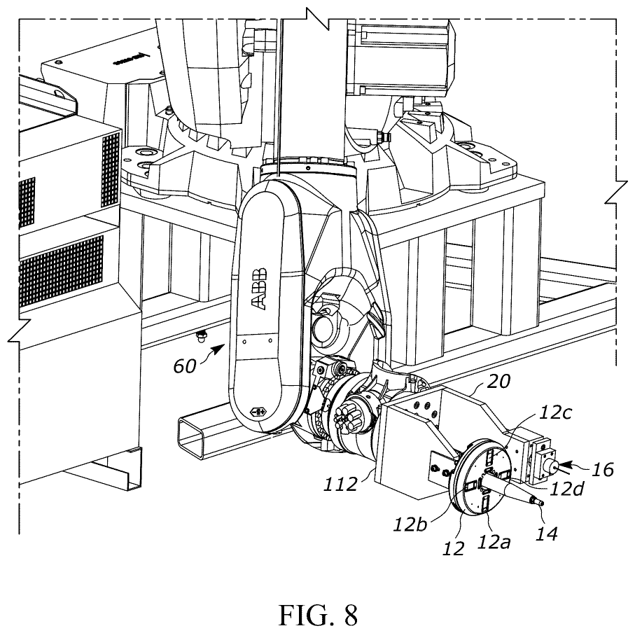

As illustrated in FIGS. 4-8, the sealant assembly 18 includes a lateral arm 70, spacing and coupling first and second support arms 72, 74. In this example embodiment, the first and second support arms 72, 74 are substantially parallel to each other. In this example embodiment, the first and second support arms 72, 74 are perpendicular to the lateral arm 70. In one example embodiment, the first support arm 72 supports the tactile sensor 16 and the second support arm supports the vison system 12 and the sealant dispensing apparatus 14. In this example embodiment, the vision system 12 includes a plurality of sensors, which work in conjunction with each other to generate three dimensional (3D) image. In one example embodiment, the vision system 12 includes first, second, third and fourth sensors 12a-12d (see FIG. 8). In one example embodiment, the first, second, third and fourth sensors 12a-12d are high-speed sensors that provide a 360-degree/3D view of the surface 206, 206a that the sealant dispensing assembly 14 is dispensing on. One example of a vision system is the vision system sold by Coherix A185 sensor, part no. 905-0121 the datasheet being incorporated herein by reference.

In this example embodiment, the sealant dispensing apparatus 14 includes a dispensing nozzle shaft 14b terminating at a nozzle tip 14a, the dispensing nozzle shaft 14b coupled to and in fluid communication with a gear pump 20. In this example embodiment, the gear pump dispensing sealant based upon a volume of sealant supplied, wherein more sealant is dispensed when the gear pump pumps at a higher speed, and less sealant is dispensed when the gear pump pumps at a lower speed. One example of a gear pump is the gear pump sold by Yaskawa, part no. BAS020-72 the datasheet being incorporated herein by reference. In this example embodiment, the sealing dispensing apparatus 14 is coupled to a sealant supply.

Views of the sealant station 60 constructed in accordance with one example embodiment of the present disclosure are illustrated in FIGS. 4-8. The sealant station 60 comprises the articulating arm 62, and a support stand 66. The tactile sensor 16, the sealant dispensing apparatus 14, and the vision system 12 are enabled and actuated by instructions from the controller 112 to translate and rotate into a position relative to selected portions of a frame 200 or sash 200a. The controller 112 co-ordinates the operation of the tactile sensor 16, the sealant dispensing apparatus 14, and the vision system 12, and various functions associated therewith.

In the illustrated example embodiment, the articulating arm 62 is a six-axis articulating arm, that is, the arm is capable of translation in the X, Y, and Z axial directions as well rotation about each axis Rx, Ry, Rz, as illustrated by the coordinate system illustrated in FIG. 6. The sealant station 62 includes a base 102, a first member 104, a first arm 106, a second member 107, a second arm 108, and a third member 112. The base 102 rotates about the Y axis, thus rotating the first member 104, first arm 106, second member 107, second arm 108, third member 112, and tool support assembly 68. The first member 104 rotates about the X axis, thus rotating the first arm 106, second member 107, second arm 108, third member 112, and tool support assembly 68. The second member 107 rotates about the X axis, thus rotating the second arm 108, third member 112, and tool support assembly 68. The third member 112 rotates about the X axis, thus rotating the tool support assembly 68.

Secured to the third member 112 is a coupling 114 that is mechanically attachable to the support assembly 68. The arm 62 rotates about the Y axis, thus rotating the coupling 114 and tool support assembly 68. The sealant assembly 18 can be oriented to rotate about the Z axis when needed. In one example embodiment, the articulating arm is a six-axis arm manufactured by ABB of Zurich, Switzerland sold under part number ABB-IRB4600, the datasheet being incorporated herein by reference.

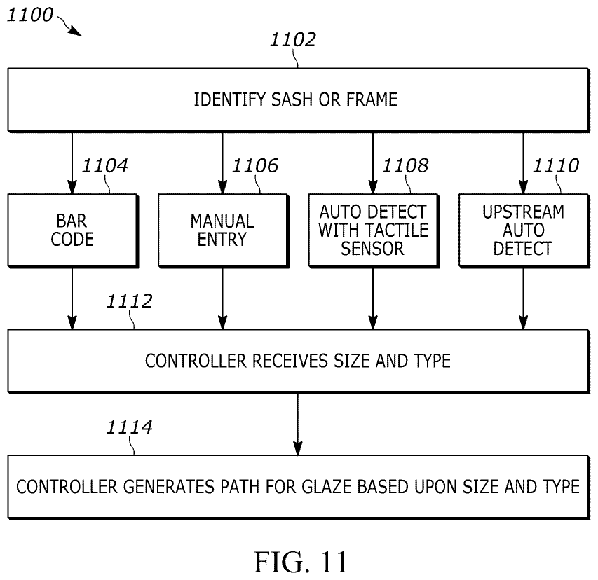

During use, and as illustrated in the example method 1100 of FIG. 11, at 1102, the sash or frame 200, 200a size and type is identified. At 1104, the system 100 identifies the sash or frame 200, 200a size and type via a bar code attached the frame or sash coded with the type information. At 1106, the system 100 identifies the sash or frame 200, 200a size and type via receiving a manual entry from a user. At 1108, the system 100 identifies the sash or frame 200, 200a size and type via tactile interaction of the tactile sensor 16 with the frame or sash. At 1110, the system 100 identifies the sash or frame 200, 200a size and type via received input from one of the upstream stations of the integrated system 10. At 1112, the controller 112 receives the size and type of the frame or sash 200, 200a. At 1114, the controller 112 generates a path for the glaze or sealant based upon the identified size and type of the frame or sash 200, 200a. In one example embodiment, the plurality of sensors 12 identify the sash or frame 200, 200a size and type.

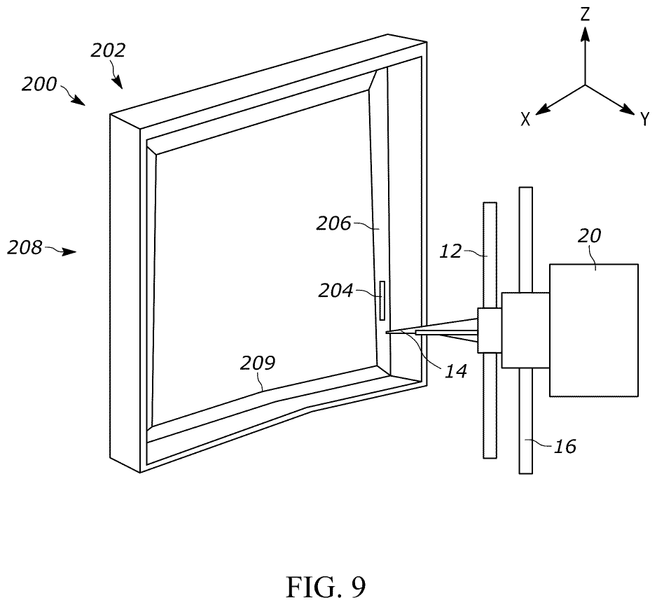

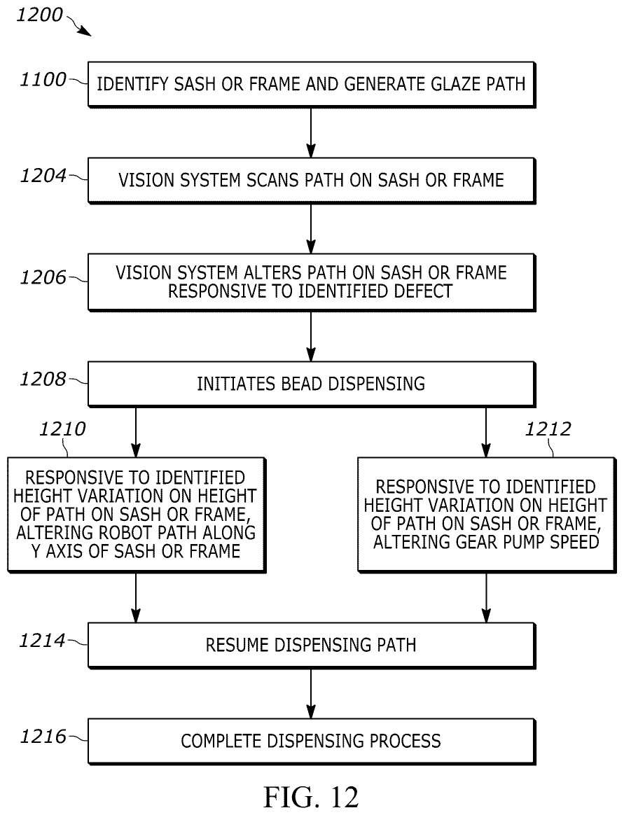

During use, and as illustrated in the example method 1200 of FIG. 12, the sash or frame type is identified and a glazing path is generated as described in method 1100. 1204, the vision system 12 scans the glazing path 206, 206a on the sash or frame 202, 202a. In one example embodiments, the coordinates of a defect 209 are identified by vision system 12. In this example embodiment, the coordinates of the defect 209 are stored by the controller 112. In one example embodiment, the defect 209 is a height variation wherein the defect extends along the y-axis as illustrated in FIG. 9. In another example embodiment, the defect 209 is a lateral variation wherein the defect extends along the x-axis as illustrated in FIG. 9. In yet another example embodiment, the defect 209 is both a height variation and lateral variation wherein the defect extends along both the y and x-axis as illustrated in FIG. 9.

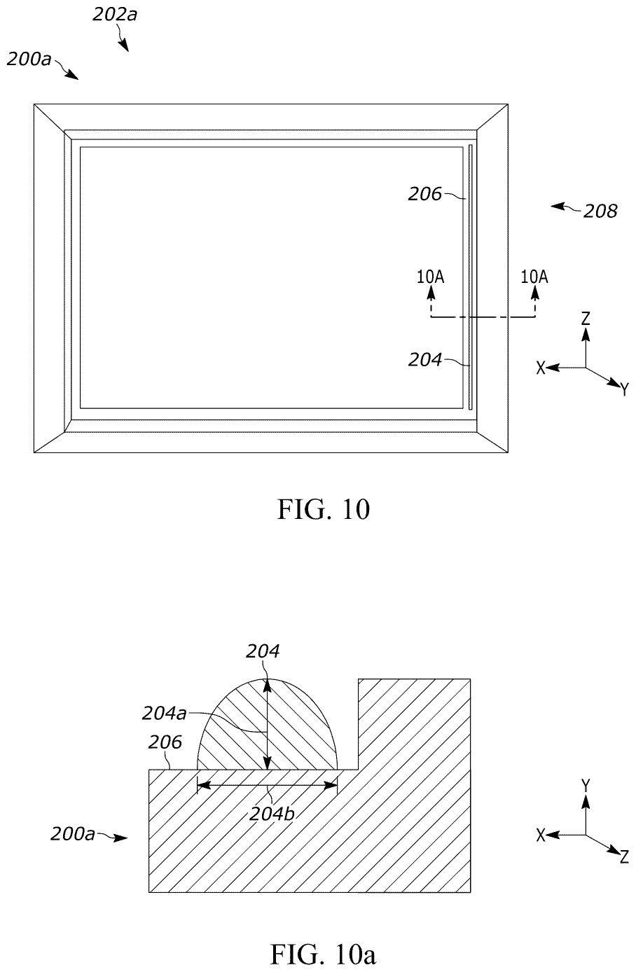

At 1206, the controller 112 instructs that the articulating arm 62 to move the sealant dispensing apparatus 14 along the path 206, 206a, and instruct the gear pump 20 to function at a speed that in conjunction with the articulating arm 62 speed will result in a bead of the sealant having a preset width and height 204a, 204b (see FIG. 10A). At 1208, the controller 112 instructs that the bead dispensing is initiated at an identified start point. In this example embodiment, the controller 112 sets the speed of the gear pump 20 and a speed of the articulating arm 62 to result in the preset width/diameter and height of the bead 204a, 204b. In this example embodiment, the preset width/diameter and height 204a, 204b are determined by the controller 112 based upon the generated glazing path. In one example embodiment, the preset width/diameter 204b is between 0.100 and 0.350 inches. In one example embodiment, the preset width/diameter 204b is 0.200 inches or 0.250 inches. In another example embodiment, the preset height 204a is between 0.05 inches and 0.200 inches. In another example embodiment, the preset height 204a is 0.10 inches and 0.125 inches. In one example embodiment, the width 204b is a diameter of the bead, wherein the bead is substantially a half circle, or half oval.

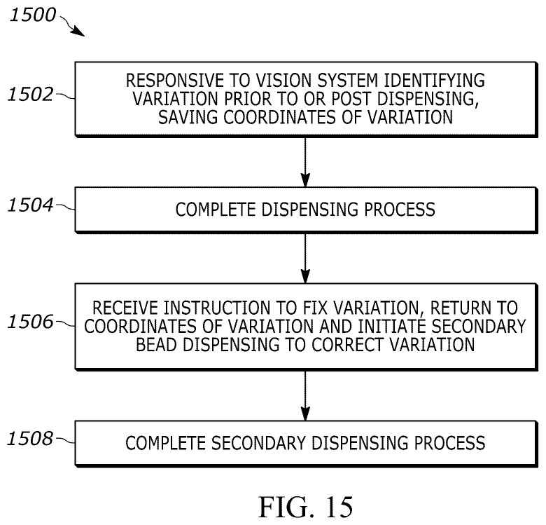

At 1210, responsive to height variation being identified by the visions system 12, the articulating arm 62 alters a height (e.g., along the y-axis) of the glazing path 206, 206a at the coordinates of the defect 209. In one example embodiment, the path scan at 1204 identifies the defect 209. In another example embodiment, the vision system 12 identifies the defect 209 during the bead dispensing of step 1208, wherein one of the first or third sensor 12b, 12d that is on a leading side of the dispensing path 206, 206a identifies the defect. In yet another example embodiment, the vision system 12 identifies the defect 209 during the bead dispensing of step 1208, wherein one of the first or third sensor 12b, 12d that is on a trailing side of the dispensing path 206, 206a identifies the defect created by the bead dispensing, and the vision system sends the coordinates to the controller 112, which stores the defect coordinates for use in repair (described below at FIG. 15 in greater detail).

At 1212, responsive to height variation being identified by the visions system 12, the controller 112 alters a gear pump 20 speed in the path area of the defect 209. In one example embodiment, the path scan at 1204 identifies the defect 209 as altering the path such that a different bead width or height than the preset width or height will result in path coverage. In this example embodiment, the gear pump 20 increases speed while dispensing sealant over the area of the defect 209 to create a larger width than the preset width, and/or a larger height than the preset height, such as when the height variation increases a coverage area on the gaze path 206, 206a, of the frame or sash 202, 202a. In another example embodiment, the gear pump 20 decreases dispensing speed while dispensing sealant over the area of the defect 209 to create a smaller width than the preset width, and/or a smaller height than the preset height, such as when the height variation decreases the coverage area on the glazing path 206, 206a, of the frame or sash 202, 202a.

At 1214, the sealant dispensing apparatus 14 resumes sealant dispensing and bead creation along the glazing path 206, 206a, once the path and/or gear speed alteration responsive to the defect 209 has been completed. It would be understood by one or ordinary skill in the art that steps 1210 and 1212 can be performed simultaneously, in sequence, or that either step 1210 or 1212 is individually performed. At 1216, responsive to the controller 112 indicating that the glazing path has been completed, the controller 112 instructs the sealant dispensing apparatus 14 to cease dispensing sealant, and the dispensing process is complete.

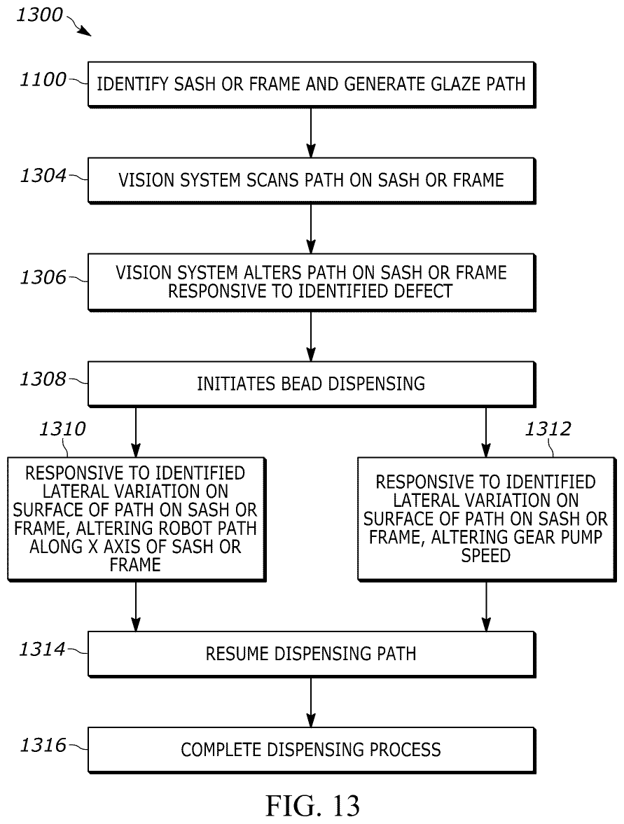

During use, and as illustrated in the example method 1300 of FIG. 13, the sash or frame type is identified and a glazing path is generated as described in method 1100. At 1304, the vision system 12 scans the glazing path 206, 206a on the sash or frame 202, 202a. In one example embodiments, the coordinates of a defect 209 are identified by vision system 12. At 1306, the controller 112 will instruct that the articulating arm 62 to move the sealant dispensing apparatus 14 along the glazing path 206, 206a, and instruct the gear pump 20 to function at a speed that in conjunction with the articulating arm speed will result in a bead of the sealant having a preset width and height. At 1208, the controller 112 instructs that the sealant dispensing and bead creation is initiated at an identified start point.

At 1310, responsive to the lateral variation being identified by the visions system 12, the articulating arm 62 alters the path relative to a width (e.g., along the x-axis) of the path 206, 206a at the coordinates of the defect 209. In one example embodiment, the defect 209 is a narrowing of the glazing path 206, 206a, responsive to the presence of a glazing block 210 (see FIG. 6). In this example embodiment, responsive to the glazing path 206, 206a adjacent to the glazing block 210 being greater than a preset width of the bead, the articulating arm alters the dispensing path to bypass or work around the glazing block. In one example embodiment, the path scan at 1204 identifies the defect 209. In another example embodiment, the vision system 12 identifies the defect 209 during the bead creation of step 1308, wherein one of the first or third sensor 12b, 12d that is on a leading side of the glazing path 206, 206a identifies the defect. In yet another example embodiment, the vision system 12 identifies the defect 209 during the bead creation of step 1308, wherein one of the first or third sensor 12b, 12d that is on a trailing side of the glazing path 206, 206a identifies the defect created by the bead creation, and the vision system sends the coordinates to the controller 112, which stores the defect coordinates for use in repair (described below in greater detail).

At 1312, responsive to the lateral variation being identified by the visions system 12, the controller 112 alters a gear pump 20 speed in the path area of the defect 209. In one example embodiment, the defect 209 is the narrowing of the path 206, 206a, responsive to the presence of one or more glazing blocks 210 (see FIG. 6). In this example embodiment, responsive to the path 206, 206a adjacent to the glazing block 210 being less than a preset width of the bead, the gear pump reduces a dispensing speed to reduce the width of the bead being dispensed relative to the preset width to bypass the glazing block. It would understood by one of ordinary skill in the art that the controller 112 moves the sealant dispensing apparatus 14 along an altered path in conjunction with reducing the dispensing speed. In one example embodiment, the path scan at 1304 identifies the defect 209 as altering the path such that a different bead width than the preset width will result in glazing path coverage. In this example embodiment, the gear pump 20 decreases dispensing speed while dispensing sealant over the area of the defect 209 to create a smaller volume than the preset volume of the bead, such as when the width variation decreases the coverage area on the glazing path 206, 206a of the frame or sash 202, 202a (e.g., such as when a glazing block 210 is present). It would be understood by one or ordinary skill in the art that steps 1310 and 1312 can be performed simultaneously, in sequence, or that either step 1310 or 1312 is individually performed. It would be further understood that that steps 1210, 1310, 1212, and 1312 can be performed simultaneously, in sequence, or that the steps may be performed individually as directed by the controller 112.

At 1314, the sealant dispensing apparatus 14 resumes bead creation along the dispensing path, once the path and/or gear speed alteration responsive to the defect 209 has been completed. At 1316, responsive to the controller 112 indicating that the glazing path has been completed, the controller 112 instructs the sealant dispensing apparatus 14 to cease dispensing sealant, and the dispensing process is complete.

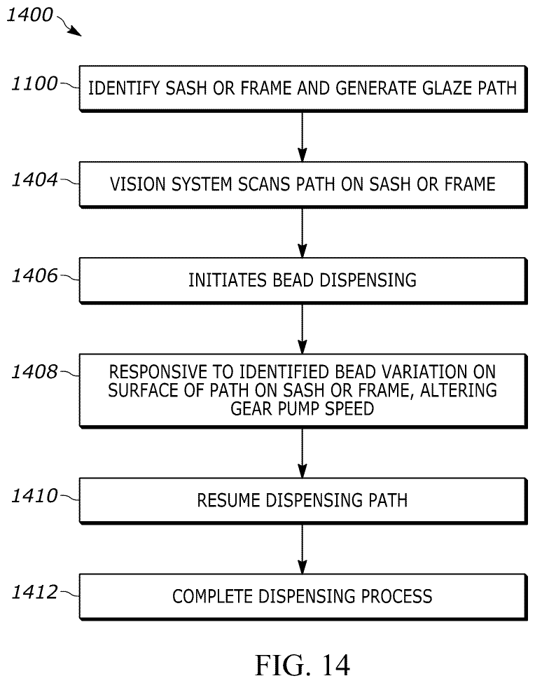

During use, and as illustrated in the example method 1400 of FIG. 14, the sash or frame type is identified and a glazing path is generated as described in method 1100. At 1404, the vision system 12 scans the glazing path 206, 206a on the sash or frame 202, 202a. In one example embodiments, the coordinates of a defect 209 are identified by vision system 12. At 1406, the controller 112 instructs that the bead creation is initiated at an identified start point.

At 1408, responsive to a bead variation on the sealant being dispensed, as identified by the visions system 12, the controller 112 instructs the gear pump 20 to alter the dispensing speed of the sealant dispensing apparatus 14. In one example embodiment, the vision system 12 identifies the defect 209 during the bead creation of step 1406, wherein one of the first or third sensor 12b, 12d that is on a trailing side of the glazing path 206, 206a identifies the bead variation created by the bead creation (e.g., such as when the articulating arm 62 slows speed in corners or sharp turns of the frame or sash 202, 202a). Stated another way, the application of the sealant is altered based upon the physical properties of the bead, for example, if the bead is too big (e.g., in either or both width/height), the controller 112 will determine that too much sealant is being dispensed. In such instances, the controller 112 will adjust the flow speed of the gear pump 20 resulting in less sealant. In another example, if the bead is too small (e.g., in either or both width/height), such as when the sealant has an air bubble, or has air contributing to volume, causing the bead to be smaller than the dispensing speed would suggest, the controller 112 will determine that too little sealant is being dispensed. In such instances, the controller 112 will increase the flow speed of the sealant. It would be understood that that steps 1210, 1310, 1212, 1312, and 1408 can be performed simultaneously, in sequence, or that the steps may be performed individually as directed by the controller 112.

At 1410, the sealant dispensing apparatus 14 resumes bead creation along the glazing path, once the gear speed alteration responsive to the bead variation has been completed. At 1412, responsive to the controller 112 indicating that the glazing path has been completed, the controller 112 instructs the sealant dispensing apparatus 14 to cease dispensing sealant, and the dispensing process is complete.

After completion of dispensing process as in steps 1216, 1316, 1412, as illustrated in the example method 1500 of FIG. 15, at 1502, responsive to the vision system 12 identifying a variation (defect 209/bead variation that was not corrected by method 1400) prior to or post bead dispensing, saving the coordinates of the variation.

At 1504, the glazing system 100 completes the dispensing process. At 1506, responsive to the controller 112 receiving instructions to fix the variation, the controller 112 instructs that the articulating arm 62 move the sealant dispensing apparatus 14 to the coordinates and initiates a secondary bead dispensing to correct the variation. In this example embodiment, the speed of the articulating arm 62 moving along the path including the variation and the speed of the sealant dispensing by the gear pump 20 is calculated by the controller 112, such that the bead height and width is calibrated to correct the variation. At 1508, the secondary bead dispensing process is complete.

Advantageously, the articulating arm 62 coupled to the vision system 12 and the sealant dispensing apparatus 14 dispenses the sealant in a reproducible manner. For example, the controller 112 alters the path of travel of the articulating arm 62 and/or alters a pump speed of the gear pump to achieve a more uniform sealant dispensing, reduce sealant waste and reduce manual downstream corrections, saving both time and money. Further, the glazing system 100 is able to automatically adjust dispensing factors, such as the glazing path and sealant dispensing speed during application to prevent dis-uniformity across multiple frames and sashes. The real-time monitoring by the glazing system 100 reduces errors, sealant used, and time manually correcting defects.

In the foregoing specification, specific embodiments have been described. However, one of ordinary skill in the art appreciates that various modifications and changes can be made without departing from the scope of the disclosure as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The disclosure is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art. In one non-limiting embodiment the terms are defined to be within for example 10%, in another possible embodiment within 5%, in another possible embodiment within 1%, and in another possible embodiment within 0.5%. The term “coupled” as used herein is defined as connected or in contact either temporarily or permanently, although not necessarily directly and not necessarily mechanically. A device or structure that is “configured” in a certain way is configured in at least that way, but may also be configured in ways that are not listed.

To the extent that the materials for any of the foregoing embodiments or components thereof are not specified, it is to be appreciated that suitable materials would be known by one of ordinary skill in the art for the intended purposes.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A glazing system for use in sealing frames and sashes, the glazing system comprising:
a vision system circumferentially or centrally supporting a sealant dispensing apparatus coupled to a first arm, the vision system supporting a plurality of sensors that generate three dimensional (3D) information, wherein a nozzle of the sealant dispensing apparatus is centrally located between the plurality of sensors, the sealant dispensing apparatus comprising the nozzle for dispensing sealant onto the frame or sash, the vision system for monitoring physical properties of the sealant during sealant application;
a tactile sensor coupled to a second arm, the second arm spaced from and coupled to the first arm by a lateral arm, the tactile sensor for physically interacting with a frame or sash;
a gear pump coupled to the nozzle, the gear pump for controlling a speed of sealant dispensing of the sealant dispensing apparatus;
an articulating arm coupled to the lateral arm, the articulating arm having a plurality of members and arms to allow movement about multiple axes defined by the articulating arm; and
a controller, coupled to and in communication with the articulating arm, the tactile sensor, the vision system, and the gear pump.

2. The glazing system of claim 1, further comprising identifying a size and type of a particular frame or sash utilizing the tactile sensor.

3. The glazing system of claim 1, wherein the controller generates a glazing path of the sealant based upon input received from the vision system.

4. The glazing system of claim 1, wherein the controller generates a glazing path of the sealant based upon an identified size and type of a particular frame or sash.

5. The glazing system of claim 4, wherein the controller generates the glazing path to include adjustments based upon detected variation in the path along an x-axis or a y-axis relative a glazing path based on an identified size and type of a particular frame or sash.

6. The glazing system of claim 3, wherein responsive to a variation in the glazing path being detected by the vision system, the controller alters a path of the sealant dispensing apparatus.

7. The glazing system of claim 1, wherein responsive to a variation in a dispensed sealant being detected by the vision system, the controller identifies the coordinates of the variation for repair.

8. The glazing system of claim 1, wherein responsive to a variation in a dispensed sealant being detected by the vision system, the controller alters a sealant flow speed of the gear pump.

9. A method of utilizing a glazing system for use in glazing frames and sashes, the method comprising the steps of:
receiving an identity of a sash or frame to be glazed;
generating a glazing path on a surface of the frame or sash based upon the identity of the sash or frame;
moving a sealant dispensing apparatus attached to an articulating arm to a starting point of the glazing path;
initiating sealant dispensing by the sealant dispensing apparatus supported by a vision system to generate a bead on the glazing path, the bead having a predetermined width and height;
monitoring the glazing path preceding and following the bead utilizing the vision system;
responsive to the vision system identifying a variation preceding the bead, identifying the coordinates of the variation, and altering the glazing path to a variation path on the sash or frame;
moving the sealant dispensing apparatus via the articulating arm to travel along the variation path;
responsive to the sealant having been dispensed along the variation path, moving the sealant dispensing apparatus to return to the glazing path;
continuing dispensing sealant along the glazing path via the sealant dispensing apparatus; and
responsive to the bead being dispensed along the glazing path and the variation path, completing the dispensing process.

10. The method of claim 9, wherein identifying a variation preceding the bead comprises identifying a height variation, wherein a portion the sash or frame extends along a y-axis relative to the rest of the sash or frame.

11. The method of claim 11, wherein responsive to identifying the height variation, altering the glazing path along the y-axis at the identified coordinates.

12. The method of claim 9, wherein identifying a variation preceding the bead comprises identifying a width variation, wherein a portion the sash or frame extends along an x-axis relative to the rest of the sash or frame.

13. The method of claim 12, wherein responsive to identifying the width variation, altering the glazing path along the x-axis at the identified coordinates.

14. The method of claim 12, wherein responsive to identifying the width variation limiting the glazing path to a width less than the predetermined bead width, altering the flow speed of the sealant to reduce a width of the bead in the identified coordinates.

15. The method of claim 9, wherein responsive to identifying a bead variation following the bead, identifying the coordinates of the bead variation.

16. The method of claim 15, further responsive to identifying the bead variation, altering a sealant dispensing speed to return the bead to the predetermined height and width.

17. The method of claim 16, further responsive to identifying the bead variation and completing the dispensing process, presenting a secondary bead dispensing to dispense sealant to remove the bead variation.

18. The method of claim 9, comprising utilizing a tactile sensor for identifying the sash or the frame to be glazed.

19. A non-transitory computer readable medium storing instructions executable by an associated processor to perform a method for implementing a glazing system comprising:
identifying a sash or frame to be glazed;
generating a glazing path passed upon the identity of the sash or frame;
initiating sealant dispensing to create a bead on the glazing path, the bead having a predetermined width and height;
monitoring the glazing path preceding and following the bead;
responsive to identifying a variation preceding the bead, identifying the coordinates of the variation, and altering the glazing path to a variation path on the sash or frame;
responsive to sealant having been dispensed along the variation path, continuing dispensing sealant along the glazing path; and
responsive to the bead being created along the glazing path, completing the dispensing process.

20. The method of claim 20, wherein responsive to the identifying the variation preceding the bead, including identifying a height variation and a width variation, at least one of:
altering the glazing path along the x and y-axis at the identified coordinates; or
altering a flow speed of the sealant to reduce a width or height of the bead in the identified coordinates.
